(19) United States
(12) Patent Application Publication
(10) Pub. No.: US 2019/0279525 A1
(43) Pub. Date: Sep. 12, 2019

(54) METHODS AND SYSTEMS TO TRAIN A USER TO REPRODUCE A REFERENCE MOTION PATTERNS WITH A HAPTIC SENSOR SYSTEM

(71) Applicant: International Business Machines Corporation, Armonk, NY (US)

(72) Inventors: Jonas Weiss, Oberrieden (CH); Erich M. Ruetsche, Pfaeffikon (CH); Patricia Sagmeister, Adliswil (CH); Thomas Gschwind, Zurich (CH); Yuksel Temiz, Zug (CH); John M. Cohn, Richmond, VT (US)

(21) Appl. No.: 15/913,506

(22) Filed: Mar. 6, 2018

(51) Int. Cl. G09B 19/00; G06F 3/01; G09B 5/00; A63B 24/00

(52) U.S. Cl. CPC G09B 19/003; G06F 3/016; A63B 69/36; A63B 24/0006; G09B 5/00

(57) ABSTRACT

A system, method and computer program product to train a user to reproduce a reference motion with a haptic feedback system having one or more sensors. The method includes receiving a user-selection of a reference motion pattern, selected from a plurality of motion patterns each of which is machine-interpretable as a time-ordered sequence of reference datasets. The sequence corresponds to a respective reference motion. The method includes capturing a user motion of a user attempting to reproduce the reference motion corresponding to the selected, reference motion pattern. This is accomplished by sampling, via the haptic feedback system, sensor values obtained from the one or more sensors, to obtain appraisal datasets that are representative of the captured user motion. A real-time haptic feedback is provided to the user while capturing the user motion based on comparisons between the appraisal datasets obtained and the reference datasets of the selected, reference motion pattern.

### BACKGROUND

The invention relates in general to the field of haptic feedback systems and haptic devices. In particular, it is directed to computerized methods for training a user to reproduce a reference motion with a haptic feedback system that comprises haptic and sensor devices, including haptic controls to provide real-time haptic feedback to a user.

A variety of social media are known, which involve computerized technologies to ease the sharing of information, videos, and other digital contents throughout virtual communities.

Besides, various sensing and haptic devices and systems are available, which allow to sense and stimulate human senses, e.g., by applying forces, vibrations and/or motions to users. Haptic stimulation is mostly achieved by way of mechanical stimulation. Haptic technology can notably be used to assist in the creation and control of virtual objects, e.g., to achieve remote control of devices, as in telerobotic applications.

### SUMMARY

According to a first aspect, the present invention is embodied as a method to train a user to reproduce a reference motion with a haptic feedback system, which system comprises one or more sensors. The method first comprises receiving a user-selection of a reference motion pattern, selected from a plurality of motion patterns. Each of the motion patterns comprises a data structure, which is machine-interpretable as a time-ordered sequence of reference datasets. The sequence corresponds to a respective reference motion. Then, the method makes it possible to capture a user motion of a user attempting to reproduce the reference motion corresponding to the selected, reference motion pattern. This is accomplished by sampling, via the haptic feedback system, sensor values obtained from the one or more sensors, to obtain appraisal datasets that are representative of the captured user motion. Finally, a real-time haptic feedback is provided to the user, via the haptic feedback system and, this, while capturing the user motion. The real-time haptic feedback is provided based on comparisons between the appraisal datasets obtained and the reference datasets of the selected, reference motion pattern.

In embodiments herein, various motion patterns can be made available to users for selection. A user can select a desired motion pattern, that is, a pattern according to which s/he wants to train. The underlying haptic feedback system is configured to provide a real-time haptic feedback to the user, e.g., when the user movement(s) depart(s) from the ideal motion, so as to allow the user to improve her(his) practice. Simple dataset structures can be relied on, which makes it possible to, e.g., replay motion patterns from devices having limiting computational capability while meeting real-time, user interactivity requirements. The present methods may notably be applied to remote control, avatar applications in robotics, geofencing, methods to learn handwriting or to play a musical instrument, as well as sport training, muscle training or other applications.

In an embodiment, the user-selection is received at a server, from which a plurality of motion patterns are available. This server may thus form part of a social media platform, whereby a community of users may possibly interact and contribute to enrich the platform, by uploading and/or sharing motion patterns.

The needed comparisons may be performed locally (at the haptic feedback system) or remotely (at or via a server). Accordingly, in a first class of embodiments, the present method further comprises, while capturing the user motion, receiving at the haptic feedback system reference datasets of the selected, reference motion pattern from the server, so as for the comparisons to be executed at the haptic feedback system. In a second class of embodiments, however, appraisal datasets as obtained via the haptic feedback system are transmitted (while capturing the user motion) to a server, for the server to execute the comparisons. Outcomes of such comparisons are next received at the haptic feedback system, such that haptic feedback can be provided to the user based on the outcomes received from the server.

In one aspect, the method further comprises, after having received the user-selection (selecting the given, reference motion pattern) and prior to capturing the user motion: transforming reference datasets of the selected, reference motion pattern, according to one or more constraints originating from the user and/or the haptic feedback system. This way, the reference motion patterns may be stored in a normalized, standard form, and latter be customized, upon request, and according to user needs or requirements from the haptic feedback system.

In that respect, the constraints, according to which reference datasets are transformed, are preferably specified in a user (or system) profile stored on the server. Such constraints may notably pertain to characteristics of the haptic feedback system. In that case, the characteristics may notably include one or more of: one or more sampling frequencies of the sensor values obtained from the one or more sensors; one or more types of physical quantities sensed by the one or more sensors; intended locations of the one or more sensors; one or more types of haptic feedback used by haptic controls of the haptic feedback system to provide haptic feedback to the user; and intended locations of the haptic controls. Such constraints may further relate to an anatomy or physiology of the user.

In embodiments, the reference datasets are received at the haptic feedback system by downloading the selected, reference motion pattern, or a transformed version thereof, to the haptic feedback system. In variants, the reference datasets are received at the haptic feedback system by streaming reference datasets of the selected, reference motion pattern, or a transformed version thereof, to the haptic feedback system, for it to execute the comparisons.

In embodiments, the method further comprises receiving the plurality of reference motion patterns at the server, from a plurality of client devices connected to the server, whereby said plurality of reference motion patterns are uploaded by different users.

Several approaches can be contemplated for performing the required comparisons. A first approach is based on a distance metric, while a second approach is primarily time-based. Thus, according to a first approach, the comparisons between the appraisal datasets obtained and the reference datasets are executed, for each of appraisal datasets obtained via the haptic feedback system, by: accessing a current appraisal dataset; identifying, in the reference datasets of the selected, reference motion pattern, a reference dataset that is the closest one to the accessed current appraisal dataset, according to a distance metric; and computing differences between values contained in the current appraisal dataset accessed and the closest one of the reference datasets identified.

According to the second approach, the comparisons between the appraisal datasets obtained and the reference datasets are executed, for each of appraisal datasets obtained via the haptic feedback system, by: accessing a current appraisal dataset and identifying an associated timestamp; identifying, in the reference datasets of the selected, reference motion pattern, a reference dataset having a timestamp matching that of the current appraisal dataset; and computing differences between values contained in the current appraisal dataset accessed and the identified reference dataset.

Other approaches use metrics that combine both time and distances, and can be regarded as a contraction of the above approaches.

The present methods further comprise populating the appraisal datasets with composite values computed as a function of two or more sensor values, as obtained from the one or more sensors, whereby said comparisons are executed by comparing such composite values to counterpart values obtained from the reference datasets. This way, the appraisal datasets can be augmented with composite values, allowing finer assessments of the user performance.

In particular, said composite values may for example be computed as differences between sensor values obtained from the one or more sensors, whereby said comparisons are executed by comparing such differences to counterpart values obtained from the reference datasets. Interestingly, said composite values are preferably obtained by computing exogenous differences between sensor values obtained from distinct sensors of the haptic feedback system, whereby said comparisons are executed by comparing such exogenous differences to counterpart values as obtained from the reference datasets.

According to another aspect, a computerized system is provided. The system comprises a haptic feedback system with: one or more sensors, each adapted to sense physical quantities relevant to a motion executed by a user, in operation; one or more haptic devices, configured to provide haptic feedback to a user, in operation; and a control unit. The control unit is operatively connected to the one or more sensors to capture a user motion of a user attempting to reproduce a reference motion of a reference motion pattern by sampling sensor values obtained from the one or more sensors, so as to obtain appraisal datasets that are representative of the captured user motion. The control unit is further operatively connected to the one or more haptic devices to provide, while capturing the user motion, a real-time haptic feedback to the user, based on comparisons between the appraisal datasets obtained and reference datasets of the reference motion pattern. The reference motion pattern comprises a data structure, which is machine-interpretable as a time-ordered sequence of the reference datasets, where the sequence corresponds to said reference motion.

Preferably, the above computerized system further comprises a server, in data communication with the haptic feedback system, and configured to receive a user-selection of a reference motion pattern, selected from a plurality of motion patterns available from the server. Each of the available motion patterns comprises a data structure, which is machine-interpretable as a time-ordered sequence of reference datasets, the sequence corresponding to a respective reference motion.

According to a further aspect, the invention can be embodied as a computer program product for training a user to reproduce a reference motion with a haptic feedback system such as described above, i.e., comprising one or more sensors. The computer program product comprises a computer readable storage medium having program instructions embodied therewith. The program instructions are executable by one or more processors, to cause to the haptic feedback system to implement steps according to the present methods.

Computerized systems, apparatuses, methods, and computer program products embodying the present invention will now be described, by way of non-limiting examples, and in reference to the accompanying drawings.

### BRIEF DESCRIPTION OF SEVERAL VIEWS OF THE DRAWINGS

FIG. 1 schematically illustrates high-level components of a haptic feedback system, including a local system in communication with a server. The local system includes both sensors, for sensing physical quantities relevant to a motion executed by a user, and haptic devices, in order to provide real-time haptic feedback to the user executing the motion, according to embodiments;

FIG. 2 is a block diagram schematically illustrating selected components and modules of a haptic feedback system, as in embodiments;

FIG. 3 is a flowchart illustrating high-level steps of methods to train a user to reproduce a reference motion with a haptic feedback system such as depicted in FIGS. 1 and 2, according to embodiments;

FIG. 4 is a flowchart illustrating high-level steps of a method for comparing appraisal datasets (obtained by capturing a motion of a user attempting to reproduce a given reference motion) with reference datasets of a reference motion pattern corresponding to the reference motion, as in embodiments;

FIG. 5 illustrates a simple, pedagogical application of the present methods, to train a user to handwriting. The view shows contours of a letter (“g”), as displayed on a handheld device. The latter forms part of a haptic feedback system, which provides real-time haptic feedback to the user when the latter drifts away from the ideal plot;

FIG. 6 is a table that aggregates appraisal datasets corresponding to a captured (sampled) motion of a user attempting to reproduce the letter shown in FIG. 5, as well as closest reference datasets, to which they are compared. The appraisal datasets include sampled pixel coordinates (x, y) of the plot being executed by the user; and

FIG. 7 schematically represents a general purpose computerized system, suited for implementing one or more method steps as involved in embodiments of the invention.

The accompanying drawings show simplified representations of devices or parts thereof, as involved in embodiments. Similar or functionally similar elements in the figures have been allocated the same numeral references, unless otherwise indicated.

### DETAILED DESCRIPTION OF EMBODIMENTS OF THE INVENTION

The following description is structured as follows. First, general embodiments and high-level variants are described (sect. 1). The next section addresses more specific embodiments and technical implementation details (sect. 2).

In the present document, a distinction is made between, on the one hand, sensors (or sensing devices), which are adapted to sense physical quantities relevant to a motion executed by a user and, on the other hand, haptic devices, which are configured to provide haptic feedback to a user, in operation. Devices in the first category (sensors) do not necessarily rely on haptic technology (i.e., relating to the sense of touch) to sense the user motion, although they preferably do. On the contrary, the devices in the second category (the haptic devices) do systematically rely on haptic technology to provide haptic feedback to the user. Now, haptic controls as used herein preferably have two functions, i.e., they involve devices, or combinations of devices, designed to both sense a user motion and provide haptic feedback, such as force feedback devices. Still, these two functions may, each, involve haptic technology (and possibly the same haptic technology).

Sensing (or capturing) a motion of user may here be performed more or less directly. In all cases, this involves collecting signals (likely in the form of digital/numerical information or electrical signals that are then converted into digital/numerical information) that capture different states relating to a user while the latter executes a motion. Such states make up a sequence that reflects the user motion. Such sensing can be performed directly (e.g., by sensing successive positions of given parts of the user's body), or indirectly (e.g., by sensing successive sound pitches of notes played by the user with a musical instrument), among other examples.

### 1. General Embodiments and High-Level Variants

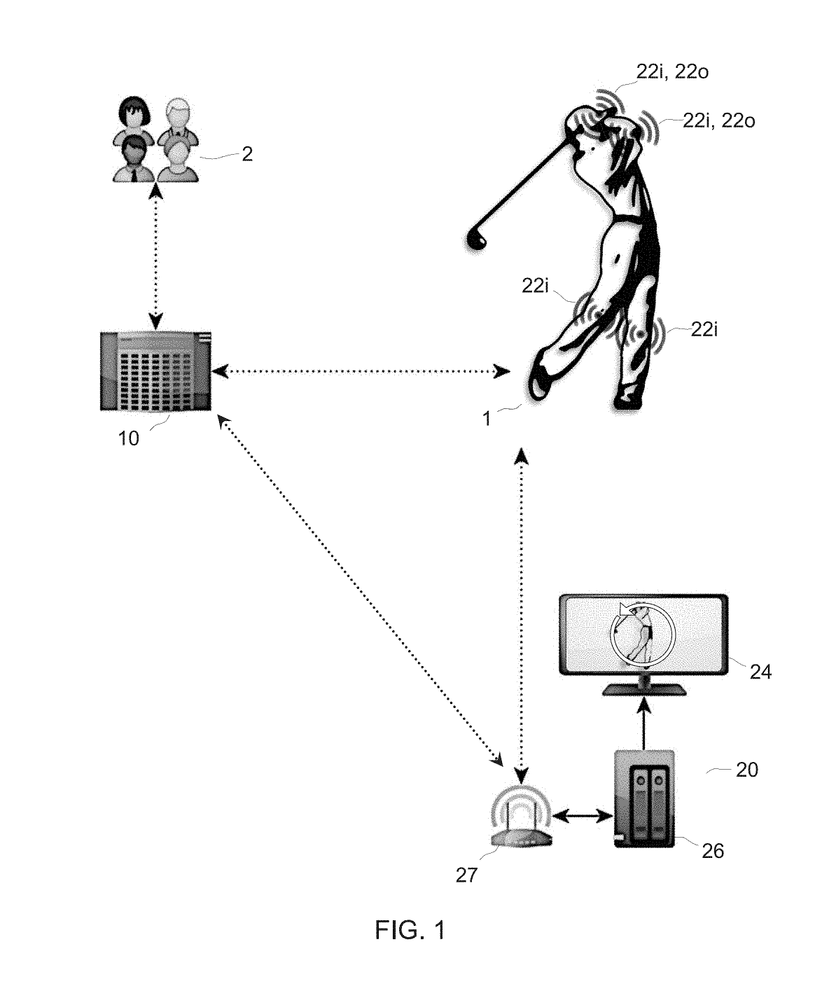

In reference to FIGS. 1-3, an aspect of the invention is first described, which concerns a method to train a user 1 to reproduce a reference motion with a haptic feedback system 20. Such a haptic feedback system 20 is depicted in FIG. 1. Briefly, the haptic feedback system 20 includes one or more sensors 22i that are, each, adapted to sense physical quantities relevant to a motion executed by a user 1. Such sensors may possibly rely on haptic technology, though this is not s strict requirement, according to the above definitions. The system further comprises one or more haptic devices 22o. Consistently with the above definitions, the latter are configured, in the system, to provide haptic feedback to the user 1, in operation. The sensors 22i and haptic devices 22o form a set of devices 22 of the system 20. The haptic feedback system 20 is later described in detail.

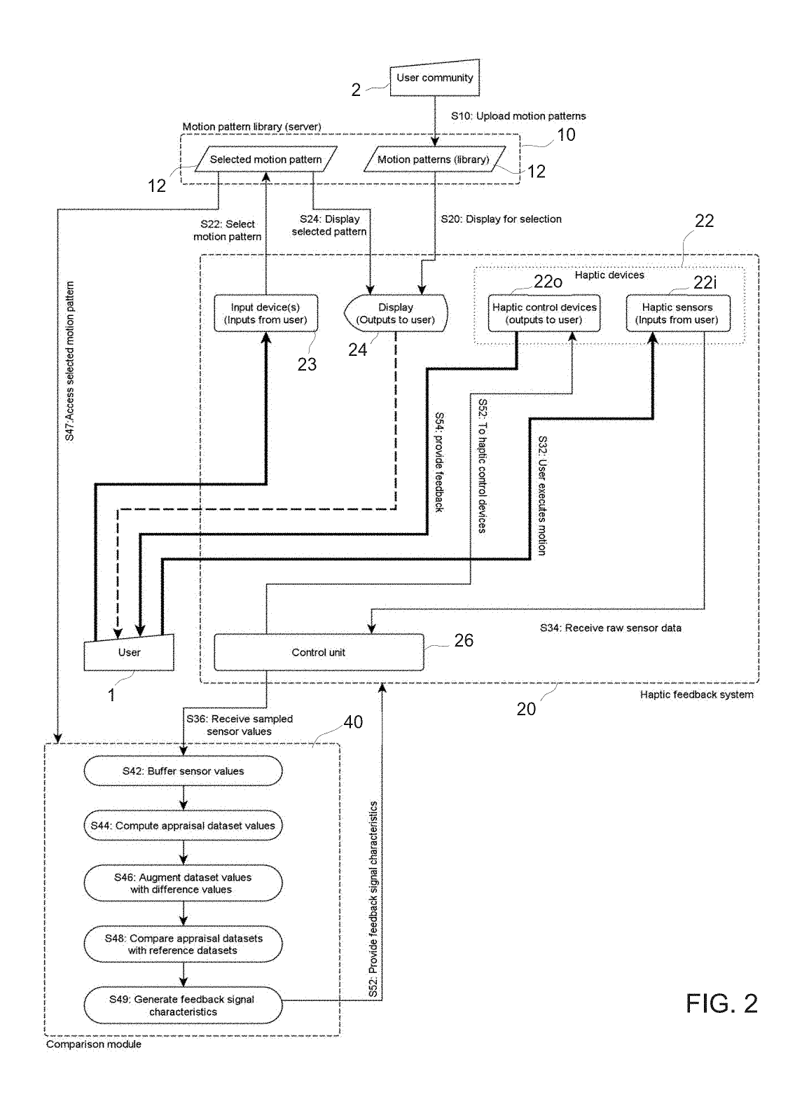

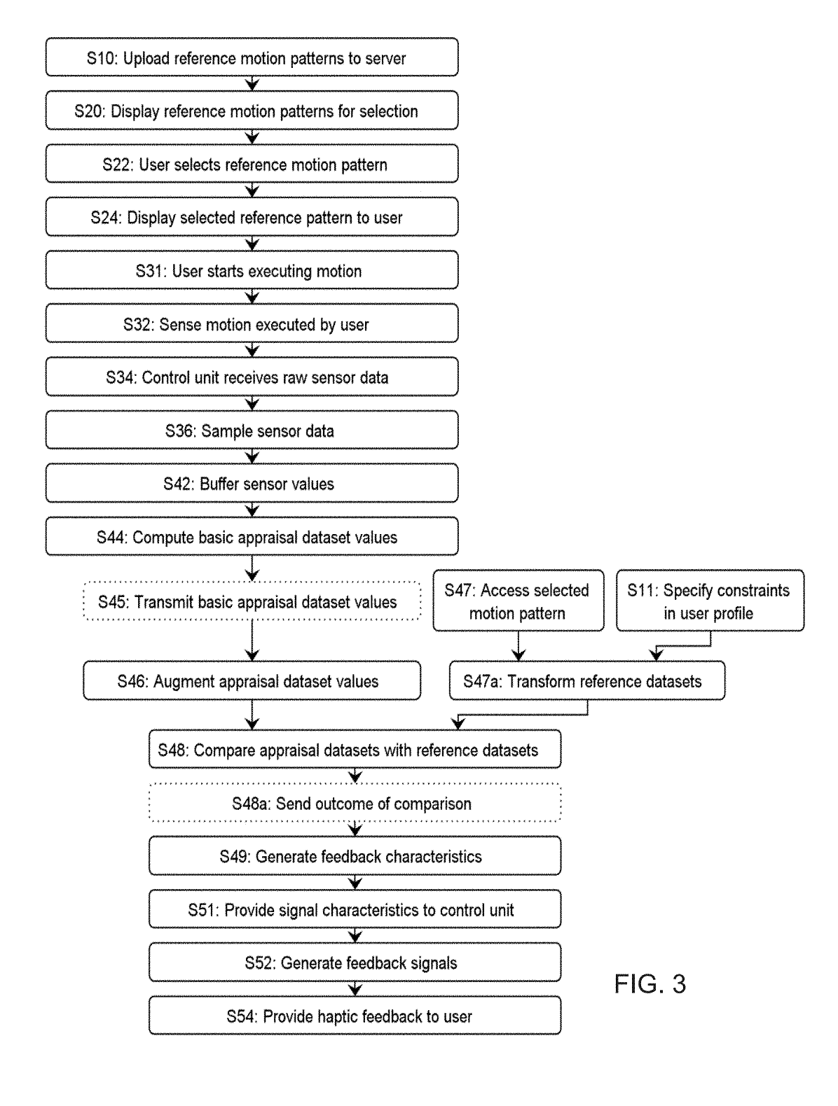

The present methods all involve a user-selection of a reference motion pattern 12. The latter is selected (step S22, FIGS. 2, 3) from a plurality of motion patterns, e.g., as available from a server 10. Each of the motion patterns (as received at the system 20 or otherwise stored on the server 10) comprises a data structure, which is machine-interpretable as a time-ordered sequence of reference datasets. As we shall see, the sequence corresponds to a respective reference motion, to be executed by the user.

Next, as the user 1 attempts to reproduce the reference motion corresponding to the selected, reference motion pattern 12, the haptic feedback system 20 captures S32-S46 the motion performed by the user 1. This is accomplished by sampling S36, via the haptic feedback system 20, sensor values obtained S32-S34 from the sensors 22i. This, in turn, makes it possible to obtain appraisal datasets S44-S46, which are representative of the captured user motion.

This way, a haptic feedback can be provided S49-S54 to the user 1, via the haptic feedback system 20, e.g., as necessary to correct the user performance. Such haptic feedback is provided in real-time, i.e., while capturing S32-S46 the user motion. The haptic feedback is further provided based on comparisons S48 between the appraisal datasets (as obtained while capturing the user motion) and the reference datasets of the selected, reference motion pattern 12.

Thanks to the present methods, a user can select S22 a desired motion pattern, that is, a pattern according to which s/he wants to train. The user may for example download the selected motion pattern and feed it as input to the haptic feedback system 20. In variants, the motion pattern selected may be streamed to the haptic feedback system 20, as discussed below.

Various motions patterns can be stored and made available to users 2 for selection. In that respect, the present server 10 may possibly form part of a social media platform, thanks to which individuals, communities and/or organizations may, e.g., share, collaboratively create, possibly modify and likely discuss motion patterns posted online. This way, a community of users 2 may interact and contribute to enrich the platform 10, by uploading their own patterns and/or by sharing motion patterns. Accordingly, reference motion patterns 11 may be continually received at the server 10, from a plurality of client devices connected to the server 10. I.e., reference motion patterns 11 may be uploaded S10 by different users 2, similarly to users uploading videos to social media platforms. The platform 10 may further allow users 2 to download and/or stream selected motion patterns, for them to train. As usual in social networking services, pattern access rights may be subject to various rules, authorizations, e.g., group-based access-rights to give the possibility for users 2 to join groups and/or pages, and then to share patterns and more. The social network service may nevertheless be primarily designed for non-social interpersonal communication or for helping users to find specific resources as to motion patterns.

All the motion patterns are then stored in a format that share a common data structure. That is, each motion pattern (as stored on the platform 10) comprises time-ordered datasets that are representative of a sequence of events making up a given motion. At least, such datasets are stored in a way that makes it possible to interpret them as a time-ordered sequence of events. In other words, a motion pattern can be associated with a certain time order, in which the events it aggregates must later be replayed for the user 1 to train.

Timestamps corresponding to each event may for instance be stored together with the datasets. In simple cases yet, the time information is implicit. I.e., datasets are basically stored in an order, associated with the order in which they must be reproduced, without further time constraints. In more sophisticated approaches, however, events may be timestamped, so as to be replayed at specific, relative times.

In all cases, the haptic feedback system 20 is configured to provide a real-time haptic feedback to the user, e.g., when the user movement(s) depart(s) from the ideal motion e.g., subject to given space and/or time tolerances.

A haptic feedback system 20 as involved herein may notably include one or more sensing devices 22, i.e., sensors capable to provide sensor values (e.g., in the form of electrical signals), indicative of successive motion states of the user, while the latter executes a motion. As said, the same sensors 22 or distinct sensors 22o (where the sensing devices are not complemented with haptic feedback capability) are used to provide real-time haptic feedback to the user as s/he executes the motion. As per previous definitions, such a feedback is haptic. I.e., one or more haptic devices are needed, which are configured to mechanically (or otherwise physically) stimulate the user, e.g., by applying forces, vibrations, or motions to the user.

More generally though, a haptic feedback system as contemplated herein may involve further user interfaces, e.g., it may involve both visual and haptic communications. Examples of suitable interface devices 22 include:

Tactile sensors, which, as part of sensor devices 22i, may be used to measure forces exerted by a user on interfaces thereof. Such device may include, e.g., tactile imaging devices, as for instance used to mimic manual palpation.

Force feedback devices, which may have a dual use (for both sensing and providing haptic feedback), such as haptic pointer devices with force feedback. A haptic force feedback device allows a user motion to be sensed and may concomitantly provide feedback to the user, based on comparisons S48 performed with reference datasets; and

Haptic devices such as bracelets, rings or gloves, arranged on limbs or other body portions. Such devices may also have a dual function, inasmuch as they may be designed to detect deviations from an ideal pattern and accordingly stimulate the user (i.e., to correct or coach the latter) by slightly vibrating, or pushing into the right direction, etc.

In general, haptic devices as involved herein may be regarded as physical stimulation devices, which can be used to accurately guide a user in accordance with a motion pattern. Closed-loop feedback may be involved to execute the motions, e.g., to train muscle memory.

Many forms of sensing and haptic communications are known, which could be used in the context of this invention. Furthermore, combination of various types of sensing/haptic communications can be contemplated. For completeness, haptic feedback may advantageously be complemented by visual feedback 24, as assumed in the examples of FIGS. 1, 2 and 5.

Thus, and as one understands, the haptic feedback system 20 may include several components, e.g., including a graphical user interface (or GUI) 24, to provide visual feedback to the user, in addition to sensors/haptic controls 22 to capture the user motion and provide haptic feedback to the user. In general, the haptic feedback system 20 may comprises any type of haptic, visual and audio devices.

Note that the terminology “real-time” as used above refers to user interactivity requirements, in terms of time elapsed between user inputs (as obtained by sensing S32-S36 the user motion) and feedbacks provided S54 to the user via the haptic feedback system 20. Such a time must be compatible with the user interactivity requirements required by the actual application. This notably means that user inputs need be collected S32-S36 at a frequency that is compatible with the real-time user interactivity requirements at stake. In particular, the sampling frequency S36 may thus be, e.g., in the range of 10 Hz to 100 Hz. It may even reach or exceed 1 kHz when using force-feedback devices. However, in applications where the executed motion is likely to be slow, the sampling frequency may be lower, e.g., between 1 and 10 Hz. Thus, the sampling frequency shall likely be in the range 1 Hz-1 kHz. Of advantage is to adapt the sampling frequency S36 to the comparison frequency S48 that is required to match real-time user interactivity requirements. Now, if needed, the sampling frequency and the comparison frequency may both be dynamically updated. I.e., subsets of the sequence may be sampled at a slower pace, while other subsets may need be sampled at a higher frequency, e.g., thanks to metadata attached to the motion pattern selected. That is, the time scale used for comparing appraisal datasets with reference datasets is not necessarily linear. The appraisal datasets and reference datasets preferably have, each, a simple data structure, as exemplified later, which makes it possible to meet demanding user interactivity requirements. Also, such simple data structures make it possible to perform comparisons at the local system 20, as in embodiments discussed herein. In general, the appraisal datasets and reference datasets may have a similar, if not identical, data structure.

In embodiments, the same devices 22 are used to both collect the user motion and provide the feedback. Although the values produced by the sensors may typically be obtained at a given, constant frequency, the sampling frequency may possibly be modified ex-ante, depending on the available sensor devices or the sophistication of the comparison method, as evoked above.

Analogic and/or digital sensors 22i may be involved. In that respect, we note that a first level of data sampling may typically be already imposed by digital sensors (typically at a constant frequency), unlike analogic sensors. Now, not all values produced by the (digital) sensors may need be taken into consideration. Thus, in embodiments, values produced by digital sensors 22i may be additionally sampled by a control unit 26 connected to the sensors 22, based on a given sampling frequency, such that a second level of sampling occurs in that case. Similarly, analogic signals need be sampled, to enable meaningful comparisons with reference datasets of reference motion patterns. Yet, a single level of sampling is typically involved in that case.

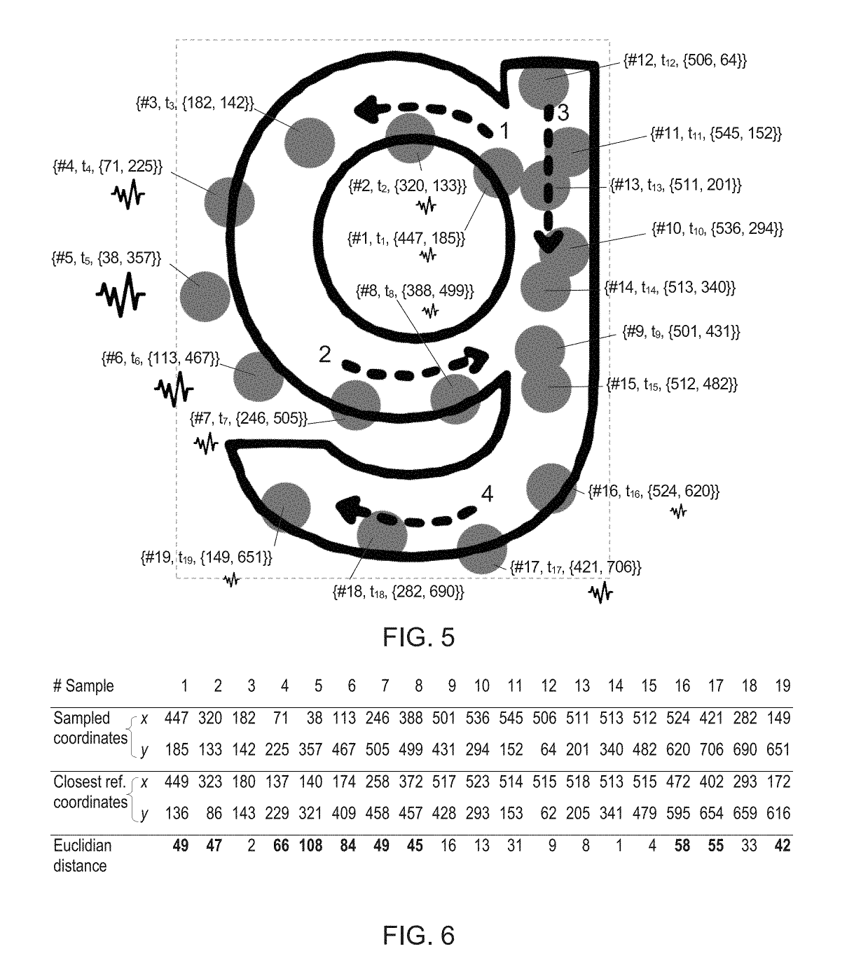

Examples of potential applications of the present methods include: remote control; avatar applications in robotics; geofencing in industry and manufacturing; methods to learn handwriting (as later exemplified in reference to FIG. 5) or to play a musical instrument; sport training; muscle training or other therapeutic applications such as motion deficiency detection or remote physiotherapy, etc.

The present approach may further involve methods for motion pattern recording, to create or refine motion patterns, thanks to appropriate edition interfaces. Embodiments of the present method may additionally involve a customization of the reference motion patterns, which may depend, e.g., on a performance level of the user 1. For example, the execution speed of the motions may be adjusted, if necessary. This adjustment may originate from the user 1 her(him)self, e.g., while completing a user profile or preferences upon registering at the server 10. In more sophisticated variants, such adjustments may be triggered, on-the-fly, from the haptic feedback system 20, or from the server 10 (where the reference motion pattern is streamed), upon detecting difficulties. This may notably be the case when the captured user motion is systematically late with respect to the replayed, reference motion pattern). More generally, the motion pattern replayed may be adapted to the users 2 and/or the devices 22, be it beforehand (prior to replaying the reference pattern) or dynamically, and possibly in an adaptive manner (while replaying the reference pattern).

All this is now described in detail, in reference to particular embodiments of the invention.

To start with, and as evoked earlier, the present methods may involve a server 10 (FIG. 1), from which a plurality of motion patterns are available. As otherwise illustrated in FIGS. 2 and 3, a user-selection of a given motion pattern may be received (step S22) at the server 10, using any suitable interface means (input devices 23), which may form part of the local system 20 (e.g., a connected handheld device or an interface provided by the system 10), the latter connected to the server 10, as assumed in FIG. 2. In less preferred variants, selection S22 is performed via another communication channel, independently from the local system 20.

Note that the server 10 may be equipped with functions to automatically extract features of the stored motion patterns, in order to, e.g., automatically categorize, sort and make the stored patterns available through a search engine and/or a web directory. In particular, one of these functions may be to automatically create icons corresponding to the stored patterns, in order to visually represent and identify the patterns and thereby help the user to make a selection S22.

The server 10, which may in fact be composed of a plurality of interconnected machines, may advantageously form part of a platform for a community 2 of users, which may hence upload, share and download motion patterns. This platform may notably be used as an infrastructure for social media, to facilitate the creation and sharing of motion pattern-related information and data.

In simpler (though less user-friendly) variants, the motion patterns are directly fed to the haptic feedback system 20, using any suitable computer readable storage medium, e.g., a memory stick, a CD/DVD, etc.

As further illustrated in FIGS. 2 and 3, reference datasets of the selected, reference motion pattern 12 are preferably received S47-S47a, from the server 10, and then processed S48 at a comparison module 40, so as for this module 40 to perform the required comparisons, in real time, i.e., while the haptic system 20 keeps on capturing S32-S46 the user motion. Now, this module 40 may be located in (or triggered by) the local haptic feedback system 20 or the server 10. Still, this module 40 may be implemented in a delocalized fashion, so as for computations S42-S49 to be performed partly at the server 10 and partly at the haptic feedback system 20, or still on a cloud available from either side 10, 20.

Thus, in embodiments, the reference datasets of the selected pattern 12 may be received S47-S47a at the haptic feedback system 20, so as for the required comparisons to be executed S48 locally, at the haptic feedback system 20, and in real time, while otherwise capturing S32-S46 the user motion. The reference datasets may notably be downloaded from the server 10 to the haptic feedback system 20, prior to replaying the reference motion pattern. In variants, the selected datasets is streamed to the haptic feedback system 20, for it to execute S48 the required comparisons. Still, a selected pattern may need be transformed prior to downloading or streaming it to the local system 20, as further discussed later.

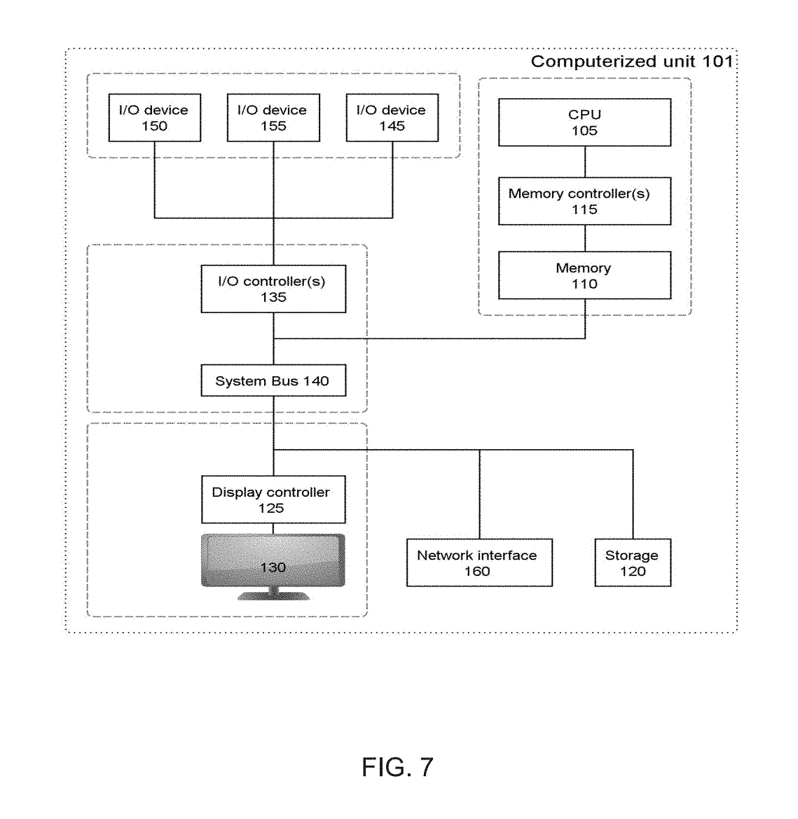

The received datasets are preferably stored on the main (non-persistent) memory of a computerized unit (such as unit 101 of FIG. 7) of the haptic feedback system 20, for it to perform comparisons on-the-fly. The received datasets need not necessarily be stored on a persistent memory thereof.

Having the comparisons S48 performed at the local system 20 can notably be contemplated if the required sampling frequency (as selected by the user or otherwise required by devices of the haptic feedback system 20) is too high and characteristics of the communication channel between the remote server 10 and the haptic feedback system 20 do not allow sufficiently short time loops to meet the real-time user interactivity requirements, as imposed by the application. This, however, assumes that the local system 20 has adequate computational power.

In variants, the comparisons are made at the server 10, assuming a suitable connection is available. Such an approach can be contemplated if the local system 20 does not have adequate computational power (e.g., the required sampling frequency is too high). In that case, appraisal datasets obtained S44 via the haptic feedback system 20 may be transmitted (optional step S45, FIG. 3) to the server 10, in real time (i.e., while otherwise capturing S32-S46 the user motion), for the server 10 to perform S48 the required comparisons. In turn, outcomes of such comparisons S48 need subsequently be sent S48a to the local system 20, for it to general haptic feedback. That is, haptic feedback is provided S49-S54 to the user 1, based on outcomes of comparisons received S48a from the server 10.

In other variants, real-time user interactivity requirements are met by outsourcing computational steps to other entities (e.g., in the cloud). In still other variants, real-time user interactivity requirements may be achieved by using two haptic feedback systems, in data communication with each other. That is, one of the systems may transmit a real-time captured pattern (e.g., as obtained from a teacher executing a movement) to the second haptic feedback system, for the latter to replay the transmitted pattern. Comparisons S48 may be performed on either side (or at a third-party), such that real-time feedback may be provided by the second haptic feedback system. In such a case too, the reference motion patterns need not be first uploaded to and downloaded or streamed from a platform. More generally, a variety of architectures (peer-to-peer, client-server, cloud-based, etc.) may be contemplated.

Again, the data structures of the patterns need not necessarily be very sophisticated, as exemplified later in reference to FIGS. 5 and 6. This way, simple data structures can be real-time transmitted for execution by a trainee, while real-time feedback can be provided to the trainee.

As noted earlier, the reference datasets of a selected motion pattern 12 may have to be transformed, according to one or more constraints, which may have various origins, as discussed now in reference to FIG. 3. The reference datasets of a selected motion pattern 12 can notably be transformed at step S47a, at any time prior to comparing S48 the datasets. Part or all of such constraints may arise from the server 10, e.g., because of a data compression scheme used at the server 10. Yet, such constraints will more likely originate from the user 1 her(him)self and/or the haptic feedback system 20. For example, the reference datasets of the selected motion pattern may notably be re-computed, to adapt the datasets to given user characteristics, e.g., as stored on user preferences or a user profile. Such user preferences/profile is preferably maintained at the server 10, though it may initially be stored on a user device or the system 20. Yet, corresponding data need be timely transmitted to enable the required transformation. User characteristics may notably include the size of the user, the user's weight, age, etc., and/or any performance value of a performance metric associated with the user.

In variants, or in addition, the datasets of the selected motion pattern may need be re-computed (e.g., upon request S22, on the server side) to adapt the datasets to given device characteristics of devices 22 used at the local system 20, e.g., the sampling frequency of such devices. To that aim, the reference datasets may advantageously be interpolated on the server side 10. The reference datasets may even be stored as an interpolant on the server 10, so as to allow quick, on-demand transformations S47.

The reference datasets may further be transformed to adapt to specific physical locations of the sensors (e.g., on the user or, more generally, where the sensing is performed) and/or the type of sensed characteristics (e.g., position, acceleration, angle, audio processing, image processing, etc.) of the sensors 22i used by the system 20. In that respect, the reference patterns may be stored according to a normalized standard, and later be denormalized, on-demand, to match user/system requirements.

As said, the transformations required are preferably performed at the server 10, especially where the local system 20 has limited computational capability. In variants, however, the local system 20 may have sufficient computational power and thus be adapted to perform such transformations. The transformations required will typically involve simple geometric transformations. Practically, such transformations will typically involve matrix multiplications, interpolations and/or extrapolations of data.

Several kind of transformations may be applied, e.g., prior to download or stream a selected motion pattern or dynamically, and possibly adaptively, e.g., while replaying the selected motion pattern. In particular, the pattern speed, the complexity level or even the selection of the pattern may be dynamically adjusted.

The constraints used to transform S47a the datasets to match requirements from the haptic feedback system 20 pertain to characteristics of the haptic feedback system 20, i.e., of sensing devices 22i thereof. Such characteristics may notably include the sampling frequencies of the sensor values obtained S32-S34 from the sensors 22i, 22. These characteristics may further pertain to the types of physical quantities sensed by the sensors 22i, 22, and/or the intended locations of the sensors. Similarly, such characteristics may also relate to the type of haptic feedback used by haptic controls 22o, and/or the intended locations of such haptic controls 22o. Any combination of such characteristics may further be taken into account to transform the stored patterns.

The sensors 22i of the haptic feedback system 20 may be regarded as spanning a multidimensional surface, i.e., forming a hyperplane. Time-dependent motions in and shapes of this hyperplane may, for each relevant timestamp, be sampled, yielding a discretization (a data structure) which reflects a user motion. Similarly, the reference motion patterns can be captured in analogous data structures, which are preferably stored in a normalized form and, if necessary, processed for storage and distribution to particular users/devices in the form of motion models. Now, at replay, such motion models may need be denormalized, in order to, e.g., match a topographical anatomy of the replayer or device (sensor) characteristics.

Many types of transformations may be involved. For example, streamed patterns 12 may be dynamically morphed, in real time. E.g., if a user consumes a motion pattern and the system 10/20 notices some difficulties (e.g., systematical or aggravating discrepancies and/or delays in the compared datasets), then the replayed pattern may be dynamically morphed into a simpler version, which may either be a pre-recorded version or be dynamically re-computed. Such recomputation may involve extrapolation from and/or interpolation between fixed points of the motion model stored. To that aim, adimensional variables are preferably used in the model (e.g., such as normalized distances or angles). Thus, the replayed pattern may possibly be adaptively transformed, in real-time (while being replayed), hence enabling seamless transformations at replay.

In addition, a particular application, as run at the local system 20, may proceed to repeat a chosen subset, or subsets, of a complex pattern, it being noted that a pattern may be sequenced as a sequence of pattern subsets, having compatible endpoints. Conversely, pattern subsets may be sequenced, on-the-fly, to form more complex patterns, while training the user. More generally, various levels of sophistications may be involved.

Besides, some motion patterns may be directed to multiple users (e.g., as in choreographic applications where a plurality of dancers have to synchronously execute a same motion or distinct motions). This implies a complex haptic feedback system 20, comprising multiple sets of devices 22 to concomitantly sense inputs and provide haptic feedback to multiple users.

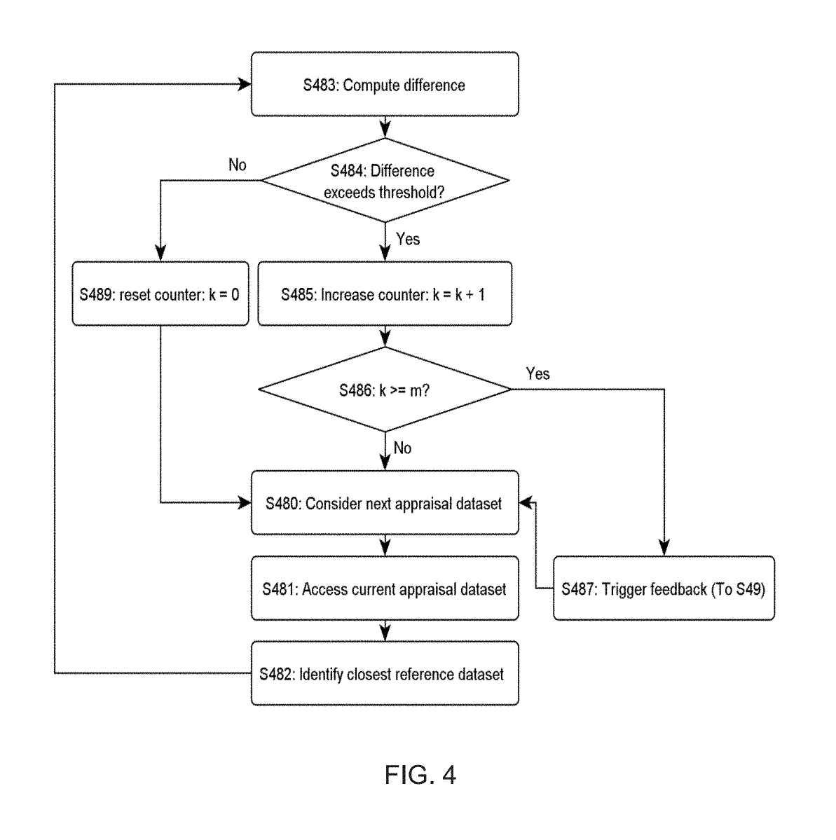

At present, additional details as to steps S42-S49 implemented by the comparison module 40 (see FIGS. 2 and 3) are discussed in reference to FIG. 4. Two approaches can notably be contemplated. Both approaches use a distance metric. However, timing considerations are implicitly taken into account in the first approach, while the second approach explicitly use timestamps for the comparisons.

In embodiments according to the first approach, comparisons between the appraisal datasets obtained through steps S32-S44 and the reference datasets from the selected pattern are executed S48 as follows. Each S480 appraisal dataset obtained via the haptic feedback system 20 is accessed S481 by the comparison module 40, one after the other and according to a given time order, which normally corresponds to the order in which the datasets were captured. Thus, there is no strict need to compare timestamps in that case. Then, for each currently accessed appraisal dataset, the comparison module 40 attempts to identify S482 a closest reference dataset amongst the reference datasets of the selected motion pattern 12, according to a given distance metric. Yet, information as to the time ordering of the reference datasets need not necessarily be considered here. Any suitable distance metric may be contemplated. This point is discussed later in detail.

Next, differences between values contained in a current appraisal dataset and the closest reference dataset identified are computed at step S483. Finally, a feedback is generated S487 (see also steps S49-S54 in FIG. 3), e.g., when such differences are found S484 to exceed a given threshold. Of course, various levels of sophistication may be contemplated. For example, one may want to impose additional constraints, e.g., a feedback may be triggered only if m successive appraisal datasets are found S485-S486 to substantially depart from their closest reference datasets, to avoid untimely feedback, as illustrated in FIG. 4. The value of m need be adapted to the application at stake; it may notably depend on the expected motion speed and/or on the sampling frequency, etc.

Both the reference datasets and the appraisal datasets are time-ordered, which implies that the n+1^{th} dataset corresponds to an event meant to occur after an event corresponding to the n^{th} dataset. Yet, in simple applications, no particular timestamp need necessarily be associated to the reference datasets, e.g., because the execution speed is not critical, as for example when learning handwriting, as later discussed in reference to FIGS. 5 and 6. There, it suffices to identify, for each observed point (e.g., as obtained from sampled pen positions, in the example of FIG. 5), a closest ideal point in space, among the reference datasets.

Such an example is now discussed in detail, in reference to FIGS. 5 and 6. FIG. 5 depicts the contours of a letter (“g”), i.e., a reference motion, as depicted by a haptic feedback application, e.g., on a touchscreen of an electronic display of an information processing system, such as a handheld device (tablet, PDA, smartphone, etc.) or on a non-tactile display of a computerized system. This way, the user is invited to reproduce a letter, or words, or full sentences, etc., for example using a compatible stylus (e.g., a capacitive stylus for capacitive touchscreens) or finger (less preferred), or with a smart-pen (to capture handwritten notes on a non-tactile visual display).

In the example of FIG. 5, the displayed letter further includes curved arrows and numbers indicating the order in which the various parts of the letter need be plotted. The depicted letter “g” corresponds to a reference motion (or part thereof), which has been selected, e.g., for a novice to train and reproduce the letter, as an exercise. This reference motion is associated to reference datasets. For example, upon being prompted (e.g., visually on the screen of a tablet), the novice starts executing the letter g, according to contours of the letter as depicted on-screen, with, e.g., with a tip applied on the touchscreen. The resulting plot is not depicted in FIG. 5. Rather, what is depicted in this example are point positions (grey disks) sampled at regular time intervals, e.g., according to steps S32-S36 of FIG. 3. Metadata associated to each grey disk in FIG. 5 can be regarded as appraisal datasets. In this example, each appraisal dataset {#n, tₙ, {x, y} } comprises: the ordinal number #n of the sampled point; an associated timestamp tₙ (obtained by timestamping the corresponding sampled point, though this is not needed in this example); as well as corresponding 2D coordinates, here {x, y} pixel coordinates of the Cartesian coordinate plane. The origin of the axes x and y is taken in the upper left corner of the image (dashed, grey border), which is a 621×771 pixel image.

The table of FIG. 6 shows successive, sampled points (steps S32-S36, FIG. 3), as well as ideal points of the reference motion that are found to be the closest to each sampled point (steps S48, FIG. 3, or steps S480-S482, FIG. 4). The last row represents Euclidian distances between each pair of points, measured in pixels (step S483, FIG. 4). Then, haptic feedback can be provided to the user (e.g., in the form of vibrations, as illustrated by oscillatory signal icons in FIG. 5), if necessary associated to additional visual feedback, based on the differences found between the two points, see FIG. 6. Thresholds can be used, which in general can be spatial and/or time-related thresholds. That is, the comparisons performed might be subjected to tolerances. In the example of FIG. 6, a lower (spatial) threshold of 40 pixels is assumed, under which threshold no feedback is triggered. Distances between pairs of points that exceed this lower threshold (in bold in the table of FIG. 6) correspond to points for which a haptic feedback (vibration) is generated. The steps are repeated as needed, see FIG. 4, for the user to complete the exercise, which may possibly involve several letters, forming words, themselves forming sentence, etc.

Beyond mere spatial tolerance, the process might be subject to additional verifications, in order to avoid untimely or inadvertent feedback, as assumed in FIG. 4. For example, the monitoring process may wait for m successive deviant samples, prior to triggering a feedback (as in steps S484-S487, FIG. 4), to mitigate feedback. In addition, at step S482, when attempting to identify a closest reference dataset, the search may optionally be restricted to a residual subset of the reference datasets that haven not been identified as closest counterparts so far.

Of course, one has to keep in mind that the above example is purposely simple, and primarily meant to illustrate concepts as involved herein, such as a reference motion (“g”), a corresponding reference motion pattern and associated datasets, as well as sampled, appraisal datasets and corresponding comparison steps.

In more sophisticated scenarios (e.g., practicing a given dance choreography or playing a musical instruments), timestamps need be explicitly considered, in addition to mere distances, whereby timestamps are necessarily attached to each appraisal dataset collected. Similarly, the reference datasets include reference timestamps. In such cases, time synchronization may be performed before appropriate (spatial) comparisons are made. Time synchronization might somehow be governed by the context (e.g., a musical context), to which a reference time scale is associated. In addition, a user may be prompted to start executing the motion (e.g., a choreography), thanks to any suitable cue (e.g., a specific sound, an introductory beat, or a visual cue, such as a count-down, etc.). In such scenarios, timestamped datasets can easily be compared, spatially, as it suffices to compare datasets pertaining to identical or closest timestamps.

The distance metric typically depends on the chosen application; it may notably be a mere Euclidian distance, as in the example of FIG. 5, or more generally be any distance derived from a p-norm for finite-dimensional vector spaces. This metric will typically allow a difference between ideal position(s) and actual position(s) of the user to be measured, where the ideal position may possibly be customized according to the context (sensing devices' characteristics and user's preferences), as discussed earlier. Yet, exceptions to this principles may arise, e.g., when the user motion is indirectly captured S32-S46. For example, in music learning applications, the local system 20 may track an actual sound pitch (a perceived frequency of a sound) and/or a beat, to detect off-key and/or off-tempo notes, rather than the actual position (e.g., of fingers or hands) of the user playing a musical instrument. Such technologies are known per se. Still, haptic feedback can nevertheless be provided, based on this indirect capture. In most applications, however, the metric will depend more directly on the motion to be executed. Now, in all cases, successive motion states are reflected in the obtained appraisal datasets.

Thus, in embodiments according to the second approach, where timing is taken into consideration, comparisons between appraisal datasets and reference datasets are executed (S48, FIG. 3) as follows. Each appraisal dataset obtained via the haptic feedback system is accessed as a current appraisal dataset, as in steps S480-S481 of FIG. 4, except that an associated timestamp is additionally identified for each appraisal dataset, at step S481. Furthermore, an additional step is needed, in order to first identify a reference dataset (or a subset of reference datasets) having a timestamp matching that of the current appraisal dataset. This can be done in essentially the same way as in step S482, FIG. 4, except that the search is restricted to reference datasets of the selected motion pattern that have compatible timestamps. That is, a closest dataset is identified from a subset of pre-selected datasets, according to a suitable distance metric. Then, differences between values contained in the current appraisal dataset and the identified reference dataset can be computed, in essentially the same way as in step S483, FIG. 4. Additional verifications may be implemented, as in steps S484-S487, FIG. 4.

Thus, the algorithm may be essentially similar to that of FIG. 4, except that the closest reference dataset is now identified taking timestamps into consideration, rather than the sole (spatial) distances.

In variants, it may be sufficient to first identify a matching (time-wise) reference dataset at step S482 (without it being required to further search a spatially closest dataset), based on which a distance can be computed, S483, thanks to values contained the respective datasets. Now, in more sophisticated scenarios, several reference datasets may be associated to a same timestamp, such that one may first need to identify time-compatible datasets (e.g., using time tolerances) and then select a closest reference dataset according to a given distance metric. In other variants, however, it may be more appropriate to first select a closest reference dataset (based on a distance metric) and then search a time-compatible reference dataset.

In still other approaches, use is made of metrics involving both time and space, so as to directly identify the closest reference datasets. That is, the metric used may further depend on time. Thus, space-time metrics may be used to directly compare the datasets. In such cases, a direct comparison can be performed, based on space-time distances provided by the metric, so as to directly identify closest reference datasets S482 and subsequently generate haptic feedback, if necessary. In addition, different metrics may be used at steps S482 and S483 in that case. For example, a space-time metric may first be used to identify a closest dataset at step S482, while a space-only metric is used to compute the difference and trigger a feedback. In variants, the distance found at step S482 can be directly re-used, to trigger a feedback.

The comparison steps may involve additional complexity; they may additionally be based on composite values, computed based on sensor values, rather than the bare sensor values. Thus, in embodiments, the present methods may further comprises populating S46 the appraisal datasets with additional, composite values, where such composite values are computed as a function of two or more sensor values, as obtained from one or more of the sensors 22i. In turn, comparisons are executed S48 by comparing such composite values to counterpart values, as obtained from the reference datasets.

The composite values may be computed at the haptic feedback system 20 or at the server 10, depending on the context. Such composite values may be considered in addition to basic sensor values, in which case the basic dataset values are augmented S46 with composite values. In variants, only the composite values are used.

Such composite values may involve a variety of functions. The composite values may for instance be computed S46 as mere differences between sensor values as obtained S32-S34 from one or more sensors 22i. In that cases, comparisons are executed S48 by comparing such differences to corresponding values from the reference datasets. For example, where positions (and/or, e.g., torsion angles) are collected S36, it may be judicious to base the comparisons on speed (and/or angular speed of the torsion angles, respectively), rather than based on the sole positions (and/or and angles, respectively). In variants, both positions (and/or angles) and speed (and/or angular speed) may be taken into account to perform the comparisons S48.

The above differences may notably involve differences between values produced by same sensors, so as to produce endogenous values (e.g., successive position values are considered to compute a speed, from a same sensor 22i). In somewhat more sophisticated embodiments, however, the composite values are obtained S46 by computing exogenous differences between sensor values obtained S32-S34 from distinct sensors of the haptic feedback system 20. That is, comparisons are subsequently executed S48 by comparing such exogenous differences to counterpart values as included in (or computed from) the reference datasets. For example, differences between various torsion angles (arising from distinct input sensors 22i) may be relevant to appreciate the accuracy with which a motion is reproduced by the user.

Moreover, exogenous differences may be taken into account, which assume a time shift. E.g., a first angle value as measured at time t at a first sensor is subtracted from a second angle value, as measured at time t−1 (or at t−l, l=2, 3, . . . ) at a second sensor. Generalizing this, if the sensors' values are regarded as a basis of vectors, one understands that non-diagonal elements of the associated tensor may be taken into consideration for haptic feedback purposes. This tensor is a multidimensional array of numerical values subtended by timestamped numerical values of the sensors. Critical information as to whether a motion is correctly reproduced may indeed be hidden in such non-diagonal values.

Beside, many techniques borrowed from classic motion capture techniques may be involved, as necessary to suitably assess the motion executed by the user.

At present, the embodiment of FIG. 3 is described in detail. It is here assumed that reference motion patterns are continually uploaded, S10, by a community 2 of users to a server 10. Upon signing up, a given user 1 may complete a profile to thereby specify S11 constraints as to the haptic system 20 and/or the user's preferences (including anatomy and/or physiology). Once registered, a user 1 may access a collection of reference motion patterns, displayed S20 to her/him for selection. After selection S22, the selected pattern is somehow rendered, or highlighted, to confirm selection thereof. Datasets of the selected pattern are then downloaded or streamed to the haptic feedback system 20 for replay, whereby the reference motion is displayed S24 to the user. At the same time, S31, the user starts to execute (reproduce) the displayed motion and sensors 22i, 22 of the haptic feedback system 20 starts sensing S32 the motion executed by the user. As the motion is being sensed, a control unit of the haptic feedback system 20 receives S34 raw sensor data, which are subsequently sampled S36, prior to being buffered at S42, awaiting for further processing. Basic appraisal dataset values are computed at S44 (either locally 20 or remotely at the server 10). If necessary, the basic appraisal dataset values are transmitted to the server 10, which may in turn augment S46 the appraisal dataset values with additional, e.g., composite values (endogenous and/or exogenous values). Comparisons with reference datasets (based on time-ordered datasets and suitable distance metric, or a space-time metric) are performed at step S48 (either locally 20 or remotely at the server 10), thanks to reference motion pattern datasets continuously accessed S47. The reference patterns may be transformed S47a on-the-fly, e.g., at the local system 20 or at the server 10 and based on given preferences S11, to match user needs or constraints of the local system 20. Feedback signal characteristics are generated at step S49, based on the comparisons performed at step S48, which in turn makes it possible to generate and provide S51 signal characteristic requirements to a control unit of the haptic feedback system 20. The latter accordingly generate S52 feedback signals, which are applied S54 by haptic controls 22o, 22 of the system 20 to provide haptic feedback to the user 1. Of course, most of the above steps are implemented concomitantly, rather than step-by-step, as the flowchart of FIG. 3 may suggest.

Referring altogether to FIGS. 1, 2 and 7, another aspect of the invention is now described, which concerns a computerized system 10, 20, or a set of interconnected machines 10, 20, configured to train a user 1 to reproduce a reference motion. This computerized system comprises at least a haptic feedback system 20. Many aspects of the haptic feedback system 20 have already been evoked in reference to the present methods; they are only briefly summarized in the following.

The haptic feedback system 20 comprises a set of devices 22, i.e., sensors 22i, which may be combined with haptic controls 22o. That is, the devices 22 include one or more input sensors 22i, which are, each adapted to sense physical quantities relevant to a motion executed by a user 1. The sensors 22 further comprise one or more haptic devices 22o, configured to provide haptic feedback to the user 1, in operation. As noted earlier, one or more of the devices 22 may be adapted to both sense a motion and provide haptic feedback, possibly based on the same haptic technology. In addition, a control unit 26 is operatively connected to the sensors 22i, so as to be able to capture the user motion as the user attempts to reproduce a reference motion (itself digitally captured as a reference motion pattern 12). As explained earlier in reference to the present methods, this is accomplished by sampling S36 sensor values as obtained S32-S34 from the sensors 22i, whereby appraisal datasets are eventually obtained S44-S46, which are representative of the captured user motion. Furthermore, the control unit 26 is operatively connected to the haptic devices 22o to interactively provide real-time haptic feedback to the user 1, i.e., while capturing S32-S46 the user motion. Haptic feedback is provided based on comparisons S48 between the appraisal datasets obtained and reference datasets of the reference motion pattern 12 selected, as explained earlier.

The server 10 may be regarded as forming part of the above computerized system. In particular, and as already described in detail, the server 10 may be in data communication with the haptic feedback system 20. The server 10 may otherwise be configured to store a plurality of motion patterns and permit S22 user-selection of a given, reference motion pattern 12. Each of the available motion patterns comprises a data structure, which is machine-interpretable as a time-ordered sequence of reference datasets, which sequence corresponds to a respective reference motion, so as to enable meaningful comparisons with appraisal datasets.

Core computations are performed by a computation module 40, see FIG. 2, which may be implemented at the haptic feedback system 20 (e.g., at the control unit 26) or at the server 10 or, still, in a delocalized fashion, across several machines, e.g., in the cloud.

FIG. 7 depicts a general computerized unit, which can be used as part of the present computerized system 10, 20 (e.g., at the haptic feedback system 20 and/or at the server 10, or in the cloud). Yet, likely embodiments of the present methods may involve virtual machines, e.g., in the cloud, dedicated to the large computations, whereas a mere handheld device may be used for sensing and for haptic feedback. Additional detail are discussed in sect. 2.

Finally, the present invention may also be embodied as a computer program product. This program may for instance be run (at least partly) on a computerized unit 101 (as in FIG. 7) of a system 10, 20. Amongst other things, this program shall typically implement functions of the comparison module 40 seen in FIG. 2. In all cases, the computer program product comprises a computer readable storage medium having program instructions embodied therewith, which program instructions are executable by a processing unit (e.g., such as unit 105 in FIG. 7), to cause the latter to take steps according to the present methods. Aspects of the present computer programs are discussed in detail in sect. 2.1 and 2.2.

The above embodiments have been succinctly described in reference to the accompanying drawings and may accommodate a number of variants. Several combinations of the above features may be contemplated. Examples are given in the next section.

### 2. Specific Embodiments; Technical Implementation Details

### 2.1 Computerized Systems and Devices

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, partly-interactive or non-interactive system. The methods described herein can be implemented in software, hardware, or a combination thereof. In exemplary embodiments, the methods described herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, the system depicted in FIG. 7 schematically represents a computerized unit 101, e.g., a general- or specific-purpose computer, which may be used as part of the computerized system 10, 20 of FIG. 1. The unit 101 may for instance form part of the haptic feedback system 20, and possibly implement the computation module 40, as part of a control unit 30, itself implemented in software, or by way of dedicated hardware modules. In that respect, the unit 101 may interact with devices 22 (22i, 22o), via suitable A/D converters (if necessary) and/or suitable I/O units 145-155.

In exemplary embodiments, in terms of hardware architecture, as shown in FIG. 7, the unit 101 includes a processor 105, and a memory 110 coupled to a memory controller 115. One or more input and/or output (I/O) devices 145, 150, 155 (or peripherals) are communicatively coupled via a local input/output controller 135. The input/output controller 135 can be coupled to or include one or more buses and a system bus 140, as known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), or generally any device for executing software instructions.

The memory 110 can include any one or combination of volatile memory elements (e.g., random access memory) and nonvolatile memory elements. Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 7, the software in the memory 110 includes computerized methods, forming part of all of methods described herein in accordance with exemplary embodiments and, in particular, a suitable operating system (OS) 111. The OS 111 essentially controls the execution of other computer programs and provides scheduling, input-output control, file and data management, memory management, and communication control and related services.

The methods described herein (or part thereof) may be in the form of a source program, executable program (object code), script, or any other entity comprising a set of instructions to be performed. When in a source program form, then the program needs to be translated via a compiler, assembler, interpreter, or the like, as known per se, which may or may not be included within the memory 110, so as to operate properly in connection with the OS 111. Furthermore, the methods can be written as an object oriented programming language, which has classes of data and methods, or a procedure programming language, which has routines, subroutines, and/or functions.

Possibly, a conventional keyboard and mouse can be coupled to the input/output controller 135. Other I/O devices 140-155 may include or be connected to sensory hardware devices 22, which communicate outputs, e.g., time series. The computerized unit 101 can further include a display controller 125 coupled to a display 130. In exemplary embodiments, the computerized unit 101 can further include a network interface or transceiver 160 for coupling to a network, to enable, in turn, data communication to/from other, external components 10, 22.

The network transmits and receives data between the unit 101 and external devices, e.g., transducers 21-28. The network is possibly implemented in a wireless fashion, e.g., using wireless protocols and technologies, such as Wifi, WiMax, etc. The network may be a fixed wireless network, a wireless local area network (LAN), a wireless wide area network (WAN) a personal area network (PAN), a virtual private network (VPN), intranet or other suitable network system and includes equipment for receiving and transmitting signals.

The network can also be an IP-based network for communication between the unit 101 and any external server, client and the like via a broadband connection. In exemplary embodiments, network can be a managed IP network administered by a service provider. Besides, the network can be a packet-switched network such as a LAN, WAN, Internet network, an Internet of things network, etc.

If the unit 101 is a PC, workstation, intelligent device or the like, the software in the memory 110 may further include a basic input output system (BIOS). The BIOS is stored in ROM so that the BIOS can be executed when the computer 101 is activated. When the unit 101 is in operation, the processor 105 is configured to execute software stored within the memory 110, to communicate data to and from the memory 110, and to generally control operations of the computer 101 pursuant to the software.

The methods described herein and the OS 111, in whole or in part are read by the processor 105, typically buffered within the processor 105, and then executed. When the methods described herein are implemented in software, the methods can be stored on any computer readable medium, such as storage 120, for use by or in connection with any computer related system or method.

### 2.2 Computer Program Products

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention has been described with reference to a limited number of embodiments, variants and the accompanying drawings, it will be understood by those skilled in the art that various changes may be made and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A method to train a user to reproduce a reference motion with a haptic feedback system, wherein the haptic feedback system comprises one or more sensors, the method comprising:
receiving a user-selection of a reference motion pattern, selected from a plurality of motion patterns, wherein each of the motion patterns comprises a data structure, which is machine-interpretable as a time-ordered sequence of reference datasets, the sequence corresponding to a respective reference motion;
capturing a user motion of a user attempting to reproduce the reference motion corresponding to the selected, reference motion pattern by sampling, via the haptic feedback system, sensor values obtained from the one or more sensors, to obtain appraisal datasets that are representative of the captured user motion; and
while capturing the user motion, providing, via the haptic feedback system, a real-time haptic feedback to the user, based on comparisons between the appraisal datasets obtained and the reference datasets of the selected, reference motion pattern.

2. The method according to claim 1, wherein
the user-selection is received at a server, from which said plurality of motion patterns are available.

3. The method according to claim 2, wherein the method further comprises, while capturing the user motion:
receiving, at the haptic feedback system, reference datasets of the selected, reference motion pattern from the server, so as for the comparisons to be executed at the haptic feedback system.

4. The method according to claim 2, wherein the method further comprises, while capturing the user motion:
transmitting the appraisal datasets obtained via the haptic feedback system to the server, for the server to execute the comparisons; and
receiving outcomes of such comparisons, whereby haptic feedback to the user is provided based on the outcomes received from the server.

5. The method according to claim 2, wherein the method further comprises, after having received the user-selection selecting the given, reference motion pattern and prior to capturing the user motion:
transforming reference datasets of the selected, reference motion pattern, according to one or more constraints originating from the user and/or the haptic feedback system.

6. The method according to claim 5, wherein
the one or more constraints are specified in a user profile stored on the server.

7. The method according to claim 5, wherein
the one or more constraints pertain to characteristics of the haptic feedback system, which characteristics include one or more of:
one or more sampling frequencies of the sensor values obtained from the one or more sensors;
one or more types of physical quantities sensed by the one or more sensors;
intended locations of the one or more sensors;
one or more types of haptic feedback used by haptic controls of the haptic feedback system to provide haptic feedback to the user; and
intended locations of the haptic controls.

8. The method according to claim 3, wherein
the reference datasets are received at the haptic feedback system by downloading the selected, reference motion pattern, or a transformed version thereof, to the haptic feedback system.

9. The method according to claim 3, wherein
the reference datasets are received at the haptic feedback system by streaming reference datasets of the selected, reference motion pattern, or a transformed version thereof, to the haptic feedback system, for it to execute the comparisons.

10. The method according to claim 2, wherein
the method further comprises receiving the plurality of reference motion patterns at the server, from a plurality of client devices connected to the server, whereby said plurality of reference motion patterns are uploaded by different users.

11. The method according to claim 1, wherein
said comparisons between the appraisal datasets obtained and the reference datasets are executed, for each of appraisal datasets obtained via the haptic feedback system, by:
accessing a current appraisal dataset;
identifying, in the reference datasets of the selected, reference motion pattern, a reference dataset that is the closest one to the accessed current appraisal dataset, according to a distance metric; and
computing differences between values contained in the current appraisal dataset accessed and the closest one of the reference datasets identified.

12. The method according to claim 1, wherein
said comparisons between the appraisal datasets obtained and the reference datasets are executed, for each of appraisal datasets obtained via the haptic feedback system, by:
accessing a current appraisal dataset and identifying an associated timestamp;
identifying, in the reference datasets of the selected, reference motion pattern, a reference dataset having a timestamp matching that of the current appraisal dataset; and
computing differences between values contained in the current appraisal dataset accessed and the identified reference dataset.

13. The method according to claim 1, wherein
the method further comprises populating the appraisal datasets with composite values computed as a function of two or more sensor values, as obtained from the one or more sensors, whereby said comparisons are executed by comparing such composite values to counterpart values obtained from the reference datasets.

14. The method according to claim 13, wherein
said composite values are computed as differences between sensor values obtained from the one or more sensors, whereby said comparisons are executed by comparing such differences to counterpart values obtained from the reference datasets.

15. The method according to claim 14, wherein
said composite values are obtained by computing exogenous differences between sensor values obtained from distinct sensors of the haptic feedback system, whereby said comparisons are executed by comparing such exogenous differences to counterpart values as obtained from the reference datasets.

16. A computerized system, comprising a haptic feedback system with:
one or more sensors, each adapted to sense physical quantities relevant to a motion executed by a user, in operation;
one or more haptic devices, configured to provide haptic feedback to a user, in operation; and
a control unit, wherein
the control unit is operatively connected to the one or more sensors to capture a user motion of a user attempting to reproduce a reference motion of a reference motion pattern by sampling sensor values obtained from the one or more sensors, so as to obtain appraisal datasets that are representative of the captured user motion; and
the control unit is operatively connected to the one or more haptic devices to provide, while capturing the user motion, a real-time haptic feedback to the user, based on comparisons between the appraisal datasets obtained and reference datasets of the reference motion pattern, the reference datasets of the reference motion pattern comprising a data structure, which is machine-interpretable as a time-ordered sequence of the reference datasets, where the sequence corresponds to said reference motion.

17. The computerized system according to claim 16, further comprising:
a server, in data communication with the haptic feedback system, and configured to receive a user-selection of a reference motion pattern, selected from a plurality of motion patterns available from the server, wherein each of the available motion patterns comprises a data structure, which is machine-interpretable as a time-ordered sequence of reference datasets, the sequence corresponding to a respective reference motion.

18. A computer program product for training a user to reproduce a reference motion with a haptic feedback system that comprises one or more sensors, the computer program product comprising a computer readable storage medium having program instructions embodied therewith, the program instructions executable by one or more processors, to cause the one or more processors to:
receive a user-selection of a reference motion pattern, selected from a plurality of motion patterns, wherein each of the motion patterns comprises a data structure, which is machine-interpretable as a time-ordered sequence of reference datasets, the sequence corresponding to a respective reference motion;
capture a user motion of a user attempting to reproduce the reference motion corresponding to the selected, reference motion pattern by sampling, via the haptic feedback system, sensor values obtained from the one or more sensors, to obtain appraisal datasets that are representative of the captured user motion; and
while capturing the user motion, provide, via the haptic feedback system, a real-time haptic feedback to the user, based on comparisons between the appraisal datasets obtained and the reference datasets of the selected, reference motion pattern.
